(19) United States
(12) Patent Application Publication
(10) Pub. No.: US 2011/0030881 A1
(43) Pub. Date: Feb. 10, 2011

(54) ADHESIVE SHEET FOR SUPPORTING AND PROTECTING SEMICONDUCTOR WAFER AND METHOD FOR GRINDING BACK OF SEMICONDUCTOR WAFER

(75) Inventors: Takatoshi SASAKI, Ibaraki-shi (JP); Fumiteru ASAI, Ibaraki-shi (JP); Kouji MIZUNO, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 12/851,890

(22) Filed: Aug. 6, 2010

(30) Foreign Application Priority Data
Aug. 7, 2009 (JP) 2009-184085

(51) Int. Cl. B32B 38/10; C09J 7/02; B32B 7/02; B32B 27/30

(52) U.S. Cl. 156/153; 428/335

(57) ABSTRACT

An adhesive sheet for supporting and protecting a semiconductor wafer has an adhesive layer formed on one side of a base film, the adhesive layer having a thickness of 4 to 42 μm and an elastic modulus at 25° C. of 0.5 to 9 MPa. The adhesive sheet of the present invention is useful in the broader application such as an adhesive sheet for affixing a wafer and for protecting a wafer, and the like in various steps of working the semiconductor wafers, that needs re-peelable.

### BACKGROUND

1. Technical Field

The present invention relates to an adhesive sheet for supporting and protecting a semiconductor wafer, and to a method for grinding the back of a semiconductor wafer, and more particularly relates to an adhesive sheet for supporting and protecting a semiconductor wafer and to a method for grinding the back of a semiconductor wafer, which can be used to advantage with semiconductor wafers having protruding bumps on their surface.

2. Related Art

Damage to the pattern surface, fouling by grinding debris, grinding water, and the like can occur in a back grinding step in which the back of a semiconductor wafer is subjected to polishing and grinding, and in a dicing step in which the wafer is cut into individual chips.

Also, the semiconductor wafer itself is thin and brittle, and in addition there are electrodes and other such protrusions on the pattern surface of the semiconductor wafer, so a problem is that even a slight external force tends to cause damage.

A method in which a back grinding tape or other such adhesive sheet is affixed to the pattern surface of a semiconductor wafer is known as a way to prevent damage, fouling, and the like to a semiconductor wafer and to protect the face on which the circuit pattern is formed, during the working of a semiconductor wafer (for example JP-2005-303068-A).

A back grinding tape usually conforms (or follows) to the surface irregularities (or protrusions, bumps, etc.) on the face of the semiconductor wafer where the circuit pattern is formed, and fills in the spaces between protrusions with an adhesive layer, which prevents grinding water or foreign objects from penetrating to the pattern formation face, and prevents cracking in the wafer during or after grinding.

However, as semiconductor devices have become smaller and their density has risen in recent years, the height of the protrusions on the circuit pattern surface of these semiconductor wafers has been on the rise, and the pitch between the protrusions has been decreasing. For example, with a wafer equipped with a polyimide film, the height difference is about 1 to 20 μm. Also, defect marks (bad marks) for recognizing defective semiconductor chips have bumps with a height difference of about 10 to 70 μm. Further, with bumps formed in the form of patterned electrodes, the height is about 20 to 200 μm, the diameter is about 100 μm, the pitch is about 200 μm or less.

Accordingly, with a conventional method employing an adhesive sheet, the sheet could not adequately conform to these bumps, and adhesion was therefore unsatisfactory between the adhesive and the wafer surface. As a result, during wafer working, problems such as sheet separation, penetration of grinding water, foreign objects, and the like to the pattern surface, improper working, dimpling, chip skipping, and the like were encountered, and damage to the wafer also occurred.

Also, when the adhesive sheet was peeled from the semiconductor wafer, the adhesive that filled the spaces between protrusions would sometimes break and leave a sticky residue on the semiconductor wafer side. This problem of sticky residue was particularly pronounced when using a relatively flexible adhesive in order to make the adhesive sheet conform to the irregularities better.

### SUMMARY

The present invention was conceived in light of the above problems, and it is an object thereof to provide an adhesive sheet for supporting and protecting a semiconductor wafer, and to a method for grinding the back of a semiconductor wafer, in which sticky residue attributable to the irregularities on the pattern formation surface of today's semiconductor wafers can be effectively prevented.

As semiconductor devices have become smaller in size with increased density in recent years, the inventors earnestly conducted research on issues such as an increase in the height of the protrusions on the pattern formation surface of semiconductor wafers, a wide variety of property of the adhesive sheet affixed to such surface protrusions, a state in which the adhesive sheet is affixed to such surface protrusions. As a result, the present invention was completed upon unexpectedly finding that a sticky residue from the adhesive layer on the protrusions of the semiconductor wafer having increasingly smaller protrusion pitch and widening difference in height between the protrusions can be reduced dramatically by contacting the adhesive layer to just the tops of the irregularities without embedding the irregularities into the adhesive layer so as to secure the adhesiveness between the adhesive sheet and the semiconductor wafer, as well as by reducing appropriately a contact area between the adhesive layer and the surface protrusions so that the adhesive sheet is controlled to conform closely to the protrusions instead of conforming strictly to the protrusions.

The present invention provides an adhesive sheet for supporting and protecting a semiconductor wafer comprising an adhesive layer formed on one side of a base film, the adhesive layer having a thickness of 4 to 42 μm and an elastic modulus at 25° C. of 0.5 to 9 MPa.

Further, the present invention provides a method for grinding the back of a semiconductor wafer comprising a step of grinding the back of the semiconductor wafer at a state in which an adhesive sheet for supporting and protecting the semiconductor wafer described above is affixed to the semiconductor wafer surface having a circuit pattern, the circuit pattern having irregularities with 15 μm or more of height from the surface of the semiconductor surface.

With the adhesive sheet of the present invention, the problem of sticky residue attributable to the irregularities on the pattern formation surface of today's semiconductor wafers can be effectively prevented.

Using this adhesive sheet affords a dramatic reduction in sticky residue when the adhesive sheet is peeled away after it is used, and also raises the yield of the product.

### BRIEF DESCRIPTION OF DRAWINGS

FIG. 1 is a schematic cross sectional view showing a bonded an adhesive sheet of the present invention to the semiconductor wafer.

### DETAILED DESCRIPTION OF EXEMPLARY EMBODIMENTS

An adhesive sheet for supporting and protecting a semiconductor wafer (hereinafter referred to as “the adhesive sheet”) of the invention mainly comprises a base film and an adhesive layer.

The adhesive sheet of the present invention is mainly used to support a semiconductor wafer or to protect its surface by being affixed to the circuit pattern formation surface of the semiconductor wafer in the manufacture of a semiconductor device using an element semiconductor (Si, Ge, etc.) or compound semiconductor (GaAs, etc.) wafer. The adhesive sheet of the present invention for supporting and protecting a semiconductor wafer is particularly useful when irregularities attributable to circuit patterns, bumps, and the like are formed on the surface of a semiconductor wafer. The adhesive sheet can be used for grinding the back of the semiconductor wafer, dicing the semiconductor wafer, and other such processing the semiconductor wafer.

The adhesive layer of the adhesive sheet of the present invention is formed from an adhesive, and there are no particular restrictions on this adhesive so long as it has the proper adhesive strength, hardness, and other such properties, and any adhesive known in this field can be used. Examples include acrylic-based adhesives, silicone-based adhesives, and rubber-based adhesives. A single type of adhesive may be used, or two or more types may be mixed. An acrylic adhesive is particularly preferable in terms of ease of adjusting the adhesive strength and ease of molecular design.

Examples of an acrylic-based polymer which is a base polymer of the acrylic-based adhesive include a polymer derived from at least one monomer component of (meth)acrylic alkyl (with 30 or fewer carbons) ester, which preferably has linear or branched alkyl groups with 4 to 18 carbons, such as methyl, ethyl, n-propyl, isopropyl, n-butyl, t-butyl, isobutyl, pentyl, isopentyl, hexyl, cyclohexyl, heptyl, 2-ethylhexyl, octyl, isooctyl, nonyl, isononyl, decyl, isodecyl, undecyl, rauryl, tridecyl, tetradecyl, stearyl, octadecyl, and dodecyl.

In this specification, the (meth)acrylate means at least one of acrylate or methacrylate.

The acrylic polymer may be added a monomer that can be copolymerized with other monomers (hereinafter referred to as “copolymerizable monomer”) for purpose of modifying an adhesive property by introducing a functional group, a polar group and the like, for improving or modifying a cohesion or thermostability by controlling a glass transition temperature of the copolymer.

Examples of such copolymerizable monomer include;

a carboxyl-containing monomer such as (meth)acrylic acid, carboxyethyl (meth)acrylate, carboxypentyl (meth)acrylate, itaconic acid, maleic acid, fumaric acid and crotonic acid;

an acid anhydride-containing monomer such as maleic anhydride and itaconic anhydride;

a hydroxyl group-containing monomer such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydodecyl (meth)acrylate, 12-hydroxyrauryl (meth)acrylate, (4-hydroxymethyl cyclohexyl)methyl(meth)acrylate;

a sulfonate-containing monomer such as styrenesulfonate, allylsulfonate, 2-(meth)acrylamide-2-methyl propanesulfonate, (meth) acrylamide propanesulfonate, sulfopropyl (meth)acrylate, (meth)acryloyloxy naphthalenesulfonate;

a phosphate-containing monomer such as 2-hydroxyethyl acryloylphosphate.

The (meth)acrylic acid alkyl ester that is the main component and the copolymerizable monomer are preferably adjusted so that the former accounts for 70 to 100 wt %, and more preferably 85 wt to 95 wt %, and the latter accounts for 0 to 30 wt %, and more preferably 5 to 15 wt %. A good balance between adhesion, cohesive strength, and the like can be obtained by using the components in amounts within these ranges.

The acrylic polymer may also include a multifunctional monomer or the like as needed, for the purpose of cross-linking and the like.

Examples of the multifunctional monomer include hexanediol di(meth)acrylate, (poly)ethyleneglycol di(meth)acrylate, (poly)propyleneglycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester (meth)acrylate and urethane (meth)acrylate.

These multifunctional monomers can be used alone or as mixture of two or more monomers.

In terms of adhesion characteristics and the like, the amount in which the multifunctional monomer is used is preferably about 30 mol % or less of the total monomer.

The acrylic polymer is obtained by polymerizing a single monomer or a mixture of two or more monomers. The polymerization can also be any method such as solution polymerization, emulsion polymerization, mass polymerization and suspension polymerization.

It is suitable for the weight average molecular weight of the acrylic polymer to be about 200,000 to 3,000,000, and preferably about 250,000 to 1,500,000. The weight average molecular weight of the polymer can be found by gel permeation chromatography (GPC).

The polymer constituting the adhesive may have a cross linked structure.

An adhesive such as this can be obtained by adding a cross linking agent to a polymer obtained from a monomer mixture containing a monomer (such as an acrylic monomer) having a carboxyl group, hydroxyl group, epoxy group, amino group, or other such functional group. With a sheet equipped with an adhesive layer containing a polymer that has a cross linked structure, the sheet is more self-supporting, so deformation of the sheet can be prevented, and the sheet can be kept flat. This means that the sheet can be affixed easily and accurately to the semiconductor wafer using an automatic affixing device or the like.

A radiation curing type adhesive as described below can be used for the adhesive layer, and introduced the cross linked structure by using a known cross-linking agent such as epoxy-based cross-linking agent, an aziridine-based cross-linking agent, an isocyanate-based cross-linking agent and a melamine-based cross-linking agent.

Examples of the epoxy compound include, for example, sorbitol tetraglycidyl ether, trimethylolpropane glycidyl ether, tetraglycidyl-1,3-bisaminomethylcyclohexane, tetraglycidyl-m-xylenediamine and triglycidyl-p-aminophenol.

Examples of the aziridine compound include, for example, 2,2-bishydroxymethylbutanol-tris[3-(1-aziridinyl)propionate] and 4,4-bis(ethyleneiminocarbonylamino)diphenylmethane.

Examples of the isocyanate compound include, for example, diphenyl methandiisosianate, tolylene diisocyanate, hexamethylene diisocyanate and polyisocyanate.

Examples of the melamine compound include, for example, hexamethoxymethylmelamine.

These cross-linking agents can be used alone or as mixture of two or more compounds. The amount is suitably adjusted to about 0.05 to 4 parts by weight per 100 parts by weight the base polymer to be cross-linked. To promote the reaction here, dibutyltin laurate or another such cross-linking catalysts that are normally used in adhesives may be used.

With the present invention, radiation curing type of adhesive for the adhesive layer may be used. Using a radiation curing type of adhesive for the adhesive layer allows the layer to be easily peeled from the wafer because irradiation lowers the adhesion when the sheet is peeled away.

As a radiation curing adhesive, an acrylic polymer having carbon-carbon double bonds or the addition to an adhesive substance of an oligomer component that forms a low adhesion substance when cured by radiation (hereinafter referred to as a radiation curing oligomer) can be used. An acrylic-based polymer having carbon-carbon double bonds and an oligomer component may also be used together.

There is no particular limitation as long as it is possible to cure polymer for example, radiation of various wavelengths, such as X rays, electron beam, ultraviolet rays, visible light rays, or infrared rays. Of these, it is preferable to use ultraviolet rays because of easy handling.

Any method known in this field can be used to introduce a carbon-carbon double bond into a side chain in the acrylic-based polymer molecule. For ease of molecular design and the like, examples of the method include a method in which a monomer having a functional group is copolymerized to an acrylic polymer, after which this polymer and a compound which has a carbon-carbon double bond and a functional group having reactivity to the functional group of the monomer are reacted (condensation, addition reaction, etc.) while radiation curing property of this carbon-carbon double bond is preserved.

Examples of the combination of the function groups include a combination of a carboxyl group and an epoxy group, a carboxyl group and an aziridine group, and a hydroxyl group and an isocyanate group. Of these, the combination of a hydroxyl group and an epoxy group is preferable from the view point of easy reaction trace.

In combinations of these functional groups, the functional groups may be either on the acrylic copolymer side or on the side of the compound having the functional group and polymerizable carbon-carbon double bond. It is preferably for the acrylic copolymer to have a hydroxyl group and for the compound having the functional group and polymerizable carbon-carbon double bond to have an isocyanate group.

Examples of the compounds having a functional group and a carbon-carbon double bond include methacryloyl isocyanate, 2-methacryloyloxyethyl isocyanate, m-isopropenyl-α,α-dimethylbenzyl isocyanate, acryloyl isocyanate, 2-acryloyloxyethyl isocyanate and 1,1-bis(acryloyloxymethyl)ethyl isocyanate.

Examples of the acrylic copolymer include a copolymer which is copolymerized ether compounds such as the above hydroxyl-containing monomers, 2-hydroxyethylvinylether, 4-hydroxybutylvinylether and diethyleneglycol monovinylether.

The acrylic copolymers having a carbon-carbon double bond can be used alone or as mixture of two or more monomers.

Examples the radiation curing oligomer which is contained in a radiation curing type adhesive include urethane-based, polyether-based, polyester-based, polycarbonate-based, polybtadiene-based and other various oligomers. In particular, examples such oligomer include trimethylolpropane tri(meth)acrylate, pentaerythritol tri(meth)acrylate, dipentaerythritol hexa(meth)acrylate, tetraethyleneglycoldi(meth)acrylate, 1,6-hexanediol(meth)acrylate, neopenthylglycoldi(meth)acrylate, an esterified compound with(meta)acrylic acid and polyol, an esterified acrylate oligomer, 2-propenyl-3-butenylcyanurate, isocyanurate and an isocyanurate compound. These oligomers can be used alone or as mixture of two or more oligomers. The oligomer is generally added in an amount of about 30 parts by weight or less, and preferably about 0 to 10 parts by weight per 100 parts by weight of the base polymer.

The radiation curing type adhesive generally contains a polymerization initiator.

Any polymerization initiator known in this field can be used.

Examples of a photopolymerization initiator include, for example,

an acetophenone photopolymerization initiator such as methoxy acetophenone, diethoxy-acetophenone (e.g., 2,2-diethoxy acetophenone), 4-phenoxydichloro acetophenone, 4-t-butyldichloro acetophenone, 2-hydroxy-2-methyl-1-phenylpropane-1-on, 1-(4-isopropylphenyl)-2-hydroxy-2-methylpropane-1-on, 1-(4-dodecylphenyl)-2-hydroxy-2-methylpropane-1-on, 4-(2-hydroxyethoxy)phenyl (2-hydroxy-2-propyl)ketone, 1-hydroxycyclohexyl phenyl ketone, 2-methyl-1-[4-(methylthio)phenyl]-2-morpholinopropane-1 and 2,2-dimethoxy-2-phenyl acetophenone;

an .-ketol photopolymerization initiator such as 4-(2-hydroxyethoxy)phenyl(2-hydroxy-2-propyl)ketone, .-hydroxy-., .′-dimethylacetophenone, 2-methyl-2-hydroxypropiophenon and 1-hydroxycyclohexylphenylketone;

a ketal photopolymerization initiator such as benzyldimethyl ketal;

a benzoine photopolymerization initiator such as benzoine, benzoine methyl ether, benzoine ethyl ether, benzoine isopropyl ether and benzoine isobutyl ether;

a benzophenone photopolymerization initiator such as benzophenone, benzoylbenzoate, benzoylbenzoate methyl, 4-phenyl benzophenone, hydroxy benzophenone, 4-benzoyl-4′-methyldiphenylsulfide and 3,3′-dimethyl-4-methoxybenzophenone;

a thioxanthone photopolymerization initiator such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone and 2,4-diisopropylthioxanthone;

an aromatic sulfonyl chloride photopolymerization initiator such as 2-naphthalene sulfonyl chloride;

a light-active oxime photopolymerization initiator such as 1-phenon-1,1-propanedione-2-(o-ethoxycarbonyl)oxime;

a specialized photopolymerization initiator such as .-acyloxim ester, methylphenyl glyoxylate, benzyl, camphor quinine, dibenzosuberone, 2-ethyl anthraquinone, 4′,4″-diethylisophthalophenone, ketone halide, acyl phosphinoxide and acyl phosphonate.

It is suitable for the polymerization initiator to be added in an amount of about 1 to 10 parts by weight per 100 parts by weight of the radiation curing type polymer (or oligomer).

The adhesive layer may also contain a component that foams or expands under heating. Examples of thermal foaming or expanding components include thermal expanding microspheres in which a substance that readily gasifies under heating, such as isobutane or propane, is encased in an elastic shell (a specific example is Microspheres® made by Matsumoto Yushi-Seiyaku). If the adhesive layer contains such a thermal foaming or thermal expanding component, then the adhesive layer can be expanded by heating after wafer grinding, which markedly reduces the contact surface area between the adhesive layer and the wafer, so the sheet can be more easily peeled from the wafer.

In addition to the above components, the adhesive may optionally comprise any known additive in the field such as a flexibilizer, antioxidant, curative agent, filler, ultraviolet absorbing agent, light stabilizer, polymerization initiator, tackifier, pigment and the like. These additives can be used alone or as mixture of two or more additives.

Regardless of the material, the adhesive layer thickness is preferably 4 to 42 μm, and more preferably about 5 to 40 μm.

Keeping the thickness within this range allows the layer to prevent excessive conformity to the irregularity and to suppress embedding between the irregularities. This effectively prevents cracking, dimpling, and the like from occurring during the grinding of the semiconductor wafer, particularly when the grinding thickness is low as in recent years.

The adhesive layer has an elastic modulus of 0.5 to 9 MPa, preferably 0.5 to 8 MPa, and more preferably 0.6 MPa or more, preferably 6.7 MPa or less, preferably 6 MPa or less, more preferably 5 MPa or less, and still more preferably 4.8 MPa or less. If a radiation curing type adhesive is used, then this elastic modulus refers to the value of the adhesive layer prior to radiation curing.

The elastic modulus referred to here is a parameter indicating the “elastic characteristics” at 25° C. in dynamic viscoelasticity measurement, and is the elastic modulus G′ at 25° C. when the intermediate layer is measured with a Rheometric Ares dynamic viscoelasticity measurement apparatus (made by Rheometric) at a frequency of 1 Hz, a plate diameter of 7.9 mm, a distortion of 1% (25° C.), and a sample thickness of 3 mm.

If the modulus of elasticity is within this range, the adhesive will have suitable hardness, so it adequately supports and protects the semiconductor wafer via the irregularities, reduces damage to the wafer, and makes the adhesive sheet easier to peel off.

Furthermore, if the adhesive layer thickness and elastic modulus are both adjusted to within these ranges, and a good balance is struck between thickness and elastic modulus, this will suppress penetration of the adhesive layer between the irregularities on the circuit formation surfaces that have become larger in recent years in semiconductor wafers, that is, it will suppress embedding of the convex components by the adhesive layer, so that just the tops of the irregularities can be securely bonded and supported preferably. Also, stress exerted on the semiconductor wafer during grinding can be preferably compensated for, and wafer cracking and dimpling can be kept to an absolute minimum. Furthermore, the proper self-support, hardness, and other such properties of the adhesive layer can be ensured, so this is particularly effective at preventing sticky residue of the adhesive layer on the semiconductor wafer, the side with the irregularities, etc.

Of these, it is suitable that (i) the adhesive layer thickness is 4 to 42 μm and elastic modulus at 25° C. is 0.5 to 9 MPa (and preferably 0.5 to 8 MPa), and more preferable that (ii) the thickness is 5 to 40 μm and elastic modulus at 25° C. is 0.5 to 9 MPa (and preferably 0.5 to 8 MPa). Further, it is more preferable that

(iii) the thickness is 4 to 42 μm and elastic modulus is 0.6 to 9 MPa (and preferably 0.6 to 8 MPa),

(iv) the thickness is 4 to 42 μm and elastic modulus is 0.6 to 6.71 MPa,

(v) the thickness is 4 to 42 μm and elastic modulus is 0.6 to 6 MPa,

(vi) the thickness is 4 to 42 μm and elastic modulus is 0.6 to 5 MPa,

(vii) the thickness is 4 to 42 μm and elastic modulus is 0.6 to 4.8 MPa,

(viii) the thickness is 5 to 40 μm and elastic modulus is 0.6 to 9 MPa (and preferably 0.6 to 8 MPa),

(ix) the thickness is 5 to 40 μm and elastic modulus is 0.6 to 6.7 MPa,

(x) the thickness is 5 to 40 μm and elastic modulus is 0.6 to 6 MPa,

(xi) the thickness is 5 to 40 μm and elastic modulus is 0.6 to 5 MPa,

(xii) the thickness is 5 to 40 μm and elastic modulus is 0.6 to 4.8 MPa.

The shear stress of the adhesive layer is preferably from 0.5 to 10 MPa, and more preferably 0.6 MPa or more, still preferably 8.5 MPa or less, still more preferably 8 MPa or less, and more preferably 6 MPa or less regardless of its material.

When the adhesive layer of the adhesive sheet is a radiation curing type, this shear stress refers to the value prior to radiation curing, that is, at the point when the adhesive sheet has been affixed to the semiconductor wafer.

The shear stress can be measured using a Tensilon RTC-1150A made by Orientec, for example. The measurement conditions in this case can be adjusted as needed, but may include a test piece size of 50×10 mm, a chuck spacing of 10 mm, and a pulling rate of 50 mm/minute, for example.

Adjusting the thickness and elastic modulus to within these ranges allows bonding to the tops of the irregularities on the semiconductor wafer to be kept tight in combination with the above-mentioned thickness and elastic modulus of the adhesive layer, and the adhesive layer suitably absorbs the stress during peeling, so the adhesive layer maintains its original shape, and sticky residue of the adhesive can be kept to an absolute minimum.

Of these, it is suitable that the adhesive layer has the thickness and elastic modulus of described above (i) and shear stress of 0.5 to 10 MPa, and preferable that the adhesive layer has the thickness and elastic modulus of described above (i) and shear stress of 0.6 to 8.5 MPa (more preferably of 0.6 to 8.5 MPa, and still more preferably off 0.6 to 6 MPa). Further, it is preferable that

the above (ii) and shear stress is 0.6 to 6 MPa,

above (iii) and shear stress is 0.6 to 6 MPa,

above (iv) and shear stress is 0.6 to 6 MPa,

above (v) and shear stress is 0.6 to 6 MPa,

above (vi) and shear stress is 0.6 to 6 MPa,

above (vii) and shear stress is 0.6 to 6 MPa,

above (viii) and shear stress is 0.6 to 6 MPa,

above (ix) and shear stress is 0.6 to 6 MPa,

above (x) and shear stress is 0.6 to 6 MPa,

above (xi) and shear stress is 0.6 to 6 MPa,

above (xii) and shear stress is 0.6 to 6 MPa.

The adhesive layer also preferably has an adhesive strength of 1.0 to 20 N/20 mm. The adhesive strength referred to here is the value measured by peeling the layer from the lead frame at a measurement temperature of 25° C., a peeling angle of 180°, and a peeling rate of 300 mm/minute (as set forth in JIS Z 0237). This measurement can be performed with a commercially available measurement apparatus (such as an Autograph AG-X made by Shimadzu Seisakusho).

If the adhesive layer of the adhesive sheet is a radiation curing type, then this adhesive strength refers to the value prior to radiation curing.

The adhesive layer of the adhesive sheet of the present invention may be formed from a single layer, but will have a laminated structure of two or more layers. In the case, each layer can be formed of the material selected from the same or different material described above.

The total thickness for the laminated structure of the adhesive layer may preferably be adapted of about 4 to 42·m.

Further, the adhesive layer as a whole preferably has the above described elastic modulus at 25° C. and shear stress. At least the adhesive layer which is a layer affixed to the semiconductor wafer may have the above described adhesive strength.

The base film of the present adhesive sheet may be formed by a thermoplastic and thermosetting resin, for example, polyester-based resin such as polyester (PET); polyolefin-based resin such as polyethylene (PE), polypropylene (PP); polyimide (PI); polyether ether ketone (PEEK); polyvinyl chloride-based resin such as polyvinyl chloride (PVC); vinylidene chloride-based resin; polyamide-based resin; polyurethane; polystylene-based resin; acrylic-based resin; fluorine-based resin; cellulose-based resin; polycarbonate-based resin; methal film; paper and the like. The base film may be a single layer or may be a laminated structure of the same material or different materials.

The semiconductor wafer supporting and protecting sheet of the present invention may be rolled-up as a tape. In this case, a release film layer may be laminated on top to protect the adhesive layer. The release film layer can be formed from a plastic film such as PET and PP, paper, non-polar material such as PE and PP, or the like that have undergone a conventional silicone treatment or fluorine treatment.

The thickness of the base film may be adapted generally of about 5 to 400·m, preferably of about 10 to 300·m, and still more preferably of about 30 to 200·m.

When the adhesive layer discussed below is a radiation curing type of adhesive, the base film is preferably one that can transmit at least a specific amount of radiation (such as a resin that is transparent) so that the radiation can be applied through the base film.

The base film may be formed by a known method for film formation, for example, a wet-casting method, an inflation method, a T-die extrusion method or the like. The base film may be either non-stretched, or subjected to a uniaxial or biaxial stretching process.

There are no particular restrictions on the configuration of the adhesive sheet of the present invention, which may be in the form of a sheet, a tape, or the like. A roll-up form is also possible, in which case, if no release film layer is used, and instead a release treated layer is provided to the opposite side of the base film (that is, the side in contact with the adhesive layer when the sheet has been rolled-up), or a parting layer (separator) is laminated, this will facilitate rewinding.

The release treated layer can be formed using a release agent that is known in this field. Examples include layers that have undergone a silicone treatment, fluorine treatment, long-chain alkyl group-containing polymer treatment, and the like.

The adhesive sheet of the present invention can be formed by coating the base film with the adhesive composition to form an adhesive layer. To apply the adhesive composition, roll coating, screen coating, gravure coating, or another such coating method may be utilized, and the coating may be formed directly on the base film, or may be transferred to the base film after first being formed on release paper whose surface has undergone a release treatment, etc.

The semiconductor supporting and protecting sheet of the present invention can be used to advantage, for example, on semiconductor wafer surfaces having irregularities that originate in a circuit pattern, etc. The irregularity may have a height of about 15·m or more (preferably 20 to 200·m), a width of about 50 to 200·m (or diameter), and a pitch of about 100 to 300·m.

The adhesive sheet is superposed with the semiconductor wafer surface (circuit pattern formation surface) so that the side with the adhesive layer will be on the wafer side, and is affected under pressure.

For example, (i) the wafer is placed on a table, the adhesive sheet of the present invention is placed over this so that the adhesive layer is on the wafer side, and the sheet is affixed by being pressed with a compression roll or other such pressing means.

Also, (ii) the wafer and the adhesive sheet are put together as mentioned above in a pressurizable vessel (such as an autoclave), and pressure is applied inside the vessel to affix the sheet to the wafer.

Here, the sheet may be affixed while being pressed with a pressing means.

Further, (iii) the sheet can be affixed in the same manner as described above within a vacuum chamber.

In affixing the sheet by these methods, heating may be performed at about 30 to 150° C.

With the adhesive sheet affixed, the back of the semiconductor wafer is ground, for example. In this case, it is good for the amount of grinding suitably adjusted. The purpose of this is to prevent excessive pressure by the adhesive sheet onto the semiconductor wafer, excessive embedding of the irregularities on the semiconductor wafer surface by the adhesive layer, and the like, and thereby avoid breakage of the adhesive embedded between the irregularities, sticky residue on the semiconductor wafer side, and the like.

The affixed adhesive sheet is peeled off, either manually or by machine, after the grinding of the semiconductor wafer. When a radiation curing type of adhesive is used, the sheet is irradiated with a suitable radiation prior to peeling to lower the adhesive strength of the adhesive layer and allow the sheet to be peeled off more easily.

When the adhesive sheet of the present invention is used in grinding, the bump height (H) of the semiconductor wafer versus the thickness (T) of the adhesive layer is adjusted, for example, to about T/H=0.2 to 2.0. Within this range allows the adhesive layer to prevent excessive embedding of the irregularities on the semiconductor wafer surface.

The adhesive sheet for dicing a semiconductor wafer of the present invention will now be described in detail on the basis of examples. All parts and percentages in the examples and comparative examples are by weight unless otherwise indicated.

Firstly, the following pressure sensitive adhesives and ultraviolet curing type adhesives were prepared as materials of an adhesive layer.

### Adhesive 1 for Adhesive Layer (Pressure Sensitive Adhesive: PSA)

40 parts methyl acrylate, 10 parts acrylic acid and 60 parts 2-ethylhexyl acrylate were copolymerized to obtain an acrylic copolymer with a weight average molecular weight of 700,000 (solid content of 35%).

To 100 parts of this obtained polymer was added 1.00 parts isocyanate-based cross-linking agent (trade name “Coronate L,” made by Nippon Polyurethane Industry) and 0.05 parts epoxy cross-linking agent (trade name “tetrad C,” made by Mitsubishi gas chemical company, Inc.) to prepare a resin solution.

### Adhesive 2 for Adhesive Layer (Ultraviolet Curing Type Adhesive: UVA)

80 parts 2-ethylhexyl acrylate, 10 parts acryloyl morpholine and 10 parts 2-hydroxylethyl acrylate were copolymerized in the ethyl acetate according to the conventional method, thereby obtaining an acrylic copolymer with a weight average molecular weight of 500,000, in which to the hydroxyl groups at the side chain terminals of 2-hydroxylethyl acrylate was added the NCO groups of 2-methacryloyl oxyethylene isocyanate, and which was introduced carbon-carbon double bonds to the terminals.

To 100 parts of this obtained polymer was added 1 part photopolymerization initiator (trade name “Irgacure 651,” made by Ciba Specialty Chemicals) and 3 parts polyisocyanate compound (trade name “Coronate L,” made by Nippon Polyurethane Industry) to prepare an acrylic radiation curing type adhesive solution.

### Adhesive 3 for Adhesive Layer (Ultraviolet Curing Type Adhesive: UVA)

40 parts methyl acrylate, 10 parts acrylic acid and 60 parts 2-ethylhexyl acrylate were copolymerized to obtain an acrylic copolymer with a weight average molecular weight of 700,000 (solid content of 35%).

To 100 parts of this obtained polymer was added 20 parts UV-1700B (made by Nihon Synthesis Co. Ltd.), 3.0 parts isocyanate-based cross-linking agent (trade name “Coronate L,” made by Nippon Polyurethane Industry), 3.5 parts epoxy cross-linking agent (trade name “tetrad C,” made by Mitsubishi gas chemical company, Inc.) and 3 parts photopolymerization initiator (trade name “Irgacure 651,” made by Ciba Specialty Chemicals) to prepare an adhesive solution.

### Adhesive 4 for Adhesive Layer (Ultraviolet Curing Type Adhesive: UVA)

80 parts butyl acrylate, 5 parts acrylic acid and 20 parts cyanomethyl acrylate were copolymerized to obtain an acrylic copolymer with a weight average molecular weight of 800,000 (solid content of 30%).

To 100 parts of this obtained polymer was added 50 parts dipentaerythritol hexaacrylate (made by Nippon Kayaku Ltd.), 1.00 parts isocyanate-based cross-linking agent (trade name “Coronate L,” made by Nippon Polyurethane Industry), 0.2 parts epoxy cross-linking agent (trade name “tetrad C,” made by Mitsubishi gas chemical company, Inc.) and 1 part photopolymerization initiator (trade name “Irgacure 651,” made by Ciba Specialty Chemicals) to prepare an adhesive solution.

### Adhesive 5 for Adhesive Layer (Pressure Sensitive Adhesive: PSA)

40 parts methyl acrylate, 10 parts acrylic acid and 60 parts 2-ethylhexyl acrylate were copolymerized to obtain an acrylic copolymer with a weight average molecular weight of 700,000 (solid content of 35%).

To 100 parts of this obtained polymer was added 3.00 parts isocyanate-based cross-linking agent (trade name “Coronate L,” made by Nippon Polyurethane Industry) and 5.0 parts epoxy cross-linking agent (trade name “tetrad C,” made by Mitsubishi gas chemical company, Inc.) to prepare a resin solution.

### Example 1

The 115·m-thick ethylene-vinyl acetate copolymer (EVA) film was used as the base film.

On the base film, the pressure sensitive adhesive layer (15·m-thick) was formed.

The resin solution was used to coat a 38·m-thick silicone release-treated polyester film so that the thickness of the resulting film became 50·m after drying and was dried for 2 minutes at 140° C. to form a pressure sensitive adhesive layer of the acrylic adhesive 1.

Thus obtained pressure sensitive adhesive layer was laminated on the base film to form an adhesive sheet for supporting and protecting a semiconductor wafer and the sheet was aged for 1 day or more at 50° C.

When the adhesive strength of the sheet to the silicon wafer was measured, the result was 12 N/20 mm.

### Examples 2 to 5 and Comparative examples 1 to 4

115·m-thick ethylene-vinyl acetate copolymer (EVA) film was used as the base film which is the same base film as Example 1.

Using the adhesive as shown in Table 1, the adhesive layers were formed respectively on the base film according to Example 1 so as to have a thickness as shown in Table 1.

The obtained adhesive sheet was affixed to a silicon wafer, the wafer was ground, and the adhesive sheet was peeled off, after which the following evaluations were performed. 25 adhesive sheets were prepared for and evaluated in each of the Examples and Comparative Examples. These results are given in Table 1.

### Affixing

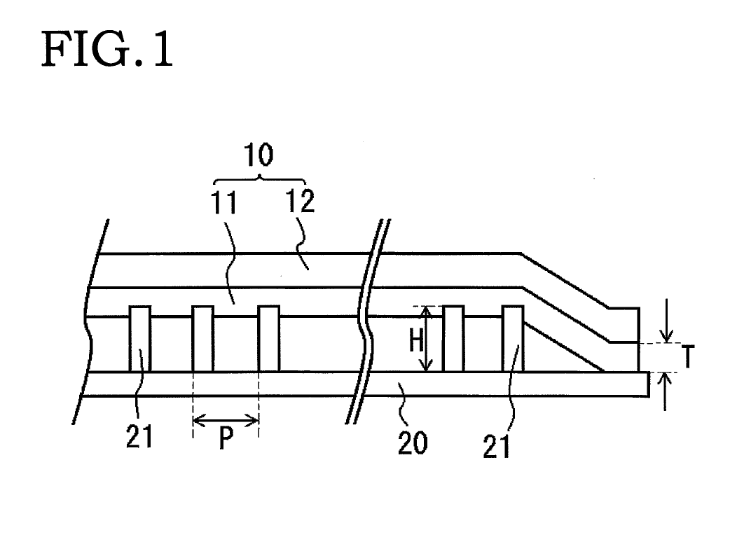

The adhesive sheet was affixed so that the adhesive layer 11 was disposed on the side of a 6-inch silicon wafer 20 on which a bump electrode 21 had been formed. The silicon wafer 20 had bump electrodes 21, each with a height H of 20 μm and a diameter of 100 μm, formed in a pitch P of 200 μm, and the wafer had a thickness of 625 μm (not including the bumps) as shown in FIG. 1. The adhesive sheet 10 was affixed with a DR-3000II made by Nitto Seiki. This corresponds to method (i) discussed above (in which the wafer is placed on a table, the adhesive sheet of the present invention is placed over this so that the adhesive layer is on the wafer side, and the sheet is affixed by being pressed with a compression roll or other such pressing means).

The adhesive layer 11 here is affixed so that only the top portions of the bump electrodes 21 are embedded, the adhesive layer 11 is not in contact between the bump electrodes 21 of the wafer 20 on the surface below the bump electrodes 21, and the adhesive sheet 10 is in contact around the outer periphery of the wafer 20 where the bump electrodes 21 are not formed, as shown in FIG. 1.

### Grinding

The wafer to which the adhesive sheet was affixed was ground down a thickness of 100 μm with a DFG 8560 silicon wafer grinder made by Disco (i.e., finally the wafer had a thickness of about 525 μm).

### Peeling

The adhesive sheet was peeled off from the ground wafer using an HR-850011 made by Nitto Seiki. When the pressure sensitive adhesive was used for the adhesive, a release tape was affixed to the back of the adhesive sheet after grinding, and the adhesive sheet was peeled off along with this tape. When the UV adhesive was used for the adhesive, the adhesive sheet was irradiated with 400 mJ/cm² of ultraviolet rays after the wafer was ground, which cured the adhesive layer, and a release tape was similarly affixed and the adhesive sheet was peeled off along with this tape.

### Evaluation Categories

### Water Penetration

This refers to a phenomenon in which grinding water seeps in between the wafer and the adhesive sheet during grinding, and the wafer is fouled by this.

After the adhesive sheet was peeled off, the wafer was observed under an optical microscope (500×). Water penetration was deemed to have occurred if water was seen on even one of the 25 wafers.

### Wafer Cracking

Wafer cracking occurs when bump irregularities are not absorbed by the adhesive sheet during grinding. Cracking was deemed to have occurred if it occurred in even one of the 25 wafers during grinding.

### Dimpling

Dimpling occurs on the back of the wafer when bump irregularities are not absorbed by the adhesive sheet during grinding. Dimpling was deemed to have occurred if dimples could be seen by eye in even one of the 25 wafers during grinding.

### Sticky Residue

After grinding, the adhesive sheet was peeled off and the outer periphery of the wafer was observed under an optical microscope (500×). The rating was “occurred” when residue of the adhesive was noted, and “non” when there was no sticky residue.

TABLE 1

| | Base Film | | Adhesive layer | | Bump | | Grinding |
|---|---|---|---|---|---|---|---|
| | | Thickness | | Thickness | Height | | Amount |
| | Type | (•m) | Type | (•m) | (•m) | T/H | (•m) |
| Ex.1 | EVA | 115 | 1 (PSA) | 15 | 20 | 0.75 | 100 |
| Ex.2 | | 115 | 2 (UVA) | 15 | | 0.75 | 100 |
| Ex.3 | | 115 | 2 (UVA) | 5 | | 0.25 | 100 |
| Ex.4 | | 115 | 2 (UVA) | 40 | | 2 | 100 |
| Ex.5 | | 115 | 3 (UVA) | 15 | | 0.75 | 100 |
| Comp. Ex.1 | EVA | 115 | 4 (UVA) | 15 | 20 | 0.75 | 100 |
| Comp. Ex.2 | | 115 | 5 (PSA) | 15 | | 0.75 | 100 |
| Comp. Ex.3 | | 115 | 2 (UVA) | 45 | | 2.25 | 100 |
| Comp. Ex.4 | | 115 | 2 (UVA) | 3 | | 0.15 | 100 |

| | Adhesive | | |
|---|---|---|---|
| | Adhesive Strength | Elastic Modulus | Shear Stress |
| | to Si (N/20 mm) | (MPa) | (MPa) |
| Ex.1 | 12 | 3.8 | 0.6 |
| Ex.2 | 2 | 0.67 | 1.5 |
| Ex.3 | 1.1 | 0.67 | 1.5 |
| Ex.4 | 4.5 | 0.67 | 1.5 |
| Ex.5 | 1.3 | 4.8 | 3.1 |
| Comp. Ex.1 | 7.1 | 0.4 | 0.45 |
| Comp. Ex.2 | 0.8 | 9.8 | 8.6 |
| Comp. Ex.3 | 5.1 | 0.67 | 1.5 |
| Comp. Ex.4 | 0.8 | 0.67 | 1.5 |

| | Water Penetration | Cracking | Dimpling | Sticky Residue |
|---|---|---|---|---|
| Ex.1 | non | non | non | non |
| Ex.2 | non | non | non | non |
| Ex.3 | non | non | non | non |
| Ex.4 | non | non | non | non |
| Ex.5 | non | non | non | non |
| Comp. Ex.1 | non | non | non | occurred |
| Comp. Ex.2 | occurred | non | non | non |
| Comp. Ex.3 | non | non | non | occurred |
| Comp. Ex.4 | occurred | non | non | non |

No “water penetration,” “wafer cracking,” “wafer dimpling,” or “wafer fouling” occurred with the adhesive sheet of the Examples, and work could be carried out effectively.

On the other hand, in Comparative Example 1, the elastic modulus and shear stress of the adhesive layer were low, and sticky residue was left on the bump electrodes.

In Comparative Example 2, the elastic modulus and shear stress of the adhesive layer were low, and the adhesive was hard, so no sticky residue was left, but the adhesive strength was low and water penetration occurred.

In Comparative Example 3, the adhesive layer was thick and embedded the surface under the bump electrodes in addition to just the top portions thereof, and sticky residue was left on the pattern surface (the bases of the bump electrodes).

In Comparative Example 4, the adhesive layer was thin, adhesive strength was inadequate, and water penetration occurred.

The adhesive sheet of the present invention is useful in the broader application such as an adhesive sheet for affixing a wafer and for protecting a wafer, and the like in various steps of working the semiconductor wafers, that needs re-peelable.

It is to be understood that although the present invention has been described in relation to preferred embodiments thereof, various other embodiments and variants may occur to those skilled in the art as within the scope and spirit of the invention, and such other embodiments and variants are intended to be covered by the following claims.

This application claims priority to Japanese Patent Application No. JP2009-184085 filed on 7 Aug. 2009. The entire disclosure of Japanese Patent Application No. JP2009-184085 is hereby incorporated herein by reference.

What is claimed is:

1. An adhesive sheet for supporting and protecting a semiconductor wafer comprising an adhesive layer formed on one side of a base film,
the adhesive layer having a thickness of 4 to 42 μm and an elastic modulus at 25° C. of 0.5 to 9 MPa.

2. The adhesive sheet for supporting and protecting a semiconductor wafer according to claim 1, wherein the adhesive layer has a shear stress of 0.5 to 10 MPa.

3. The adhesive sheet for supporting and protecting a semiconductor wafer according to claim 1, wherein the adhesive layer has an adhesive strength of 1.0 to 20 N/20 mm in the affixing step.

4. The adhesive sheet for supporting and protecting a semiconductor wafer according to claim 1, wherein the adhesive layer contains an acrylic polymer as a constituting material.

5. The adhesive sheet for supporting and protecting a semiconductor wafer according to claim 1, wherein the adhesive layer contains a radiation curing type acrylic-based polymer having carbon-carbon double bonds.

6. The adhesive sheet for supporting and protecting a semiconductor wafer according to claim 1, wherein the adhesive layer is a radiation curing type adhesive layer containing a radiation curing type oligomer.

7. A method for grinding the back of a semiconductor wafer comprising a step of grinding the back of the semiconductor wafer at a state in which an adhesive sheet for supporting and protecting the semiconductor wafer according to claim 1 is affixed to the semiconductor wafer surface having a circuit pattern,
the circuit pattern having irregularities with 15 μm or more of height from the surface of the semiconductor surface.

8. The method for grinding the back of a semiconductor wafer according to claim 7, wherein the adhesive layer of the adhesive sheet has a thickness of 0.2 to 2.0 times of the height of the irregularity.
